(19) United States
(12) Patent Application Publication
(10) Pub. No.: US 2026/0346349 A1
(43) Pub. Date: Nov. 5, 2026

(54) POWERED COPING SAW

(71) Applicant: Black & Decker Inc., New Britain, CT (US)

(72) Inventors: Logan James Butler, Hockess, DE (US); Samantha Rose Gerhart, Newark, DE (US); Matthew Charles Meredith, Wilmington, DE (US); Gavin Scott Redgrave, Toms River, NJ (US); Alexander John De Rosa, Wilmington, DE (US); Whitney Sample, Lincoln Univ., PA (US)

(21) Appl. No.: 19/662,805

(22) Filed: Apr. 29, 2026

Related U.S. Application Data
(60) Provisional application No. 63/797,756, filed on Apr. 30, 2025.

(51) Int. Cl. B23D 55/06; B23D 61/12

(52) U.S. Cl. CPC B23D 55/06; B23D 61/1265

(57) ABSTRACT

A coping saw may include a housing having a handle. A coping saw may include a frame having a first arm and a second arm. A coping saw may include a saw blade attached to the frame between the first arm and the second arm. A coping saw may include a linear mechanism having a first end and a second end, the first end affixed to the housing and the second end coupled to the first arm of the frame. A coping saw may include an actuator attached to the housing and to the second arm of the frame, the actuator operable to apply a reciprocating motion to the frame.

### CROSS REFERENCE TO RELATED APPLICATION

This application claims priority to and the benefit of U.S. Provisional Application No. 63/797,756, filed Apr. 30, 2025, and titled “Powered Coping Saw,” which is incorporated by reference in its entirety.

### TECHNICAL FIELD

This description relates generally to a powered saw, and more particularly, to a powered saw for making precision cuts such as a powered coping saw.

### BACKGROUND

When two pieces of trim or molding are brought together at an internal corner, the options are either to miter the ends being brought together to attempt a consistent meeting or to cope one of the ends being brought together. Coping refers to a special type of cut that runs along the edge of a material including when one side of a joint has the profile of the overlapping section cut to provide a better matching point. This cut is used to join two pieces of material together that may have curves or complex shapes. A current method of coping may include using a hand-powered, manual coping saw. Manual hand coping can be tiring, slow, and tedious work. Other current methods of coping may include using power tools that are not intended for coping. A dedicated, powered approach would cut down on user time and provide a safer method to cope trim that does not use power tools in unintended ways.

### SUMMARY

In some aspects, the techniques described herein relate to a coping saw including: a housing having a handle; a frame having a first arm and a second arm; a saw blade attached to the frame between the first arm and the second arm; a linear mechanism having a first end and a second end, the first end affixed to the housing and the second end coupled to the first arm of the frame; and an actuator attached to the housing and to the second arm of the frame, the actuator operable to apply a reciprocating motion to the frame.

In some aspects, the techniques described herein relate to a coping saw, wherein the linear mechanism includes: a linear rail with a first end of the linear rail affixed to the housing; and a linear bearing coupled to the first arm of the frame and slidably engaged with the linear rail.

In some aspects, the techniques described herein relate to a coping saw, wherein the linear mechanism further includes a linear adapter coupling the linear bearing to the first arm of the frame.

In some aspects, the techniques described herein relate to a coping saw, wherein the linear rail includes a square rail.

In some aspects, the techniques described herein relate to a coping saw, wherein the actuator includes: an electric motor; and a reciprocating mechanism coupled to the electric motor to convert rotational motion of the electric motor into the reciprocating motion.

In some aspects, the techniques described herein relate to a coping saw, wherein the reciprocating mechanism further includes: a set of gears to transfer the rotational motion of the electric motor to the reciprocating motion.

In some aspects, the techniques described herein relate to a coping saw, wherein the reciprocating mechanism further includes: an adapter that couples the reciprocating mechanism to the second arm of the frame.

In some aspects, the techniques described herein relate to a coping saw, wherein the adapter includes a cylindrical-shaped tube having a first end coupled to the reciprocating mechanism and a second end coupled to a threaded opening on the second arm of the frame.

In some aspects, the techniques described herein relate to a coping saw, wherein the frame includes a U-shaped frame.

In some aspects, the techniques described herein relate to a coping saw, further including: a variable speed trigger attached to the handle and operably coupled to the actuator to control a speed of the reciprocating motion of the frame.

In some aspects, the techniques described herein relate to a coping saw, wherein the housing includes a battery receptacle to receive a battery pack to power the electric motor.

In some aspects, the techniques described herein relate to a coping saw, further including: a base plate attached to the housing.

In some aspects, the techniques described herein relate to a coping saw, wherein the base plate is pivotally attached to the housing.

In some aspects, the techniques described herein relate to a coping saw, further including: a foot attached to the base plate.

In some aspects, the techniques described herein relate to a coping saw, wherein the foot includes: a base attached to the base plate; a first flat side that angles from the base to a top portion; and a second flat side that angles from the base to the top portion, the second flat side having a first flat portion and a second flat portion with an opening between the first flat portion and the second flat portion.

In some aspects, the techniques described herein relate to a coping saw, wherein the top portion of the foot is flat at the top portion and tapers from the top portion towards the base along the first flat side and the second flat side.

In some aspects, the techniques described herein relate to a coping saw, further including: a light extending from the housing.

In some aspects, the techniques described herein relate to a coping saw, wherein the light is encased in an adjustable shell.

In some aspects, the techniques described herein relate to a coping saw including: a housing having a handle; a frame having a first arm and a second arm; a saw blade attached to the frame between the first arm and the second arm; a linear mechanism having a first end and a second end, the first end affixed to the housing and the second end coupled to the first arm of the frame; an actuator attached to the housing and to the second arm of the frame, the actuator operable to apply a reciprocating motion to the frame; a base plate pivotally attached to the housing; and a foot attached to the base plate, wherein the foot includes: a base attached to the base plate; a first flat side that angles from the base to a top portion; and a second flat side that angles from the base to the top portion, the second flat side having a first flat portion and a second flat portion with an opening between the first flat portion and the second flat portion.

In some aspects, the techniques described herein relate to a coping saw, wherein the top portion of the foot is flat at the top portion and tapers from the top portion towards the base along the first flat side and the second flat side.

In some aspects, the techniques described herein relate to a coping saw, wherein the linear mechanism includes: a linear rail with a first end of the linear rail affixed to the housing; and a linear bearing attached to the first arm of the frame, the linear bearing slidably engaged with the linear rail.

In some aspects, the techniques described herein relate to a coping saw, wherein the linear mechanism further includes a linear adapter coupling the linear bearing to the first arm of the frame.

In some aspects, the techniques described herein relate to a coping saw, wherein the linear rail includes a square rail.

In some aspects, the techniques described herein relate to a coping saw, wherein the actuator includes: an electric motor; and a reciprocating mechanism coupled to the electric motor to convert rotational motion of the electric motor into the reciprocating motion.

In some aspects, the techniques described herein relate to a coping saw, wherein the reciprocating mechanism further includes: a set of gears to transfer the rotational motion of the electric motor to the reciprocating motion.

In some aspects, the techniques described herein relate to a coping saw, further including: a light extending from the housing.

In some aspects, the techniques described herein relate to a coping saw, wherein the light is encased in an adjustable shell.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example implementation of a powered coping saw in a first position.

FIG. 2 is a diagram of the example powered coping saw of FIG. 1 in a second position.

FIG. 3A is an example diagram of a reciprocating mechanism having an adapter attached to a frame of the powered coping saw.

FIG. 3B is an example diagram of a reciprocating mechanism having an adapter attached to a frame of the powered coping saw, according to another example implementation.

FIG. 4 is a partial diagram of a linear mechanism attached to the frame of the powered coping saw.

FIG. 5A is an assembled view of the linear mechanism.

FIG. 5B is an exploded view of the linear mechanism.

FIG. 6 is a partial diagram of a top view of the powered coping saw of FIG. 1.

FIG. 7 is a diagram of a top, side view of the shoe and the base plate of the powered coping saw.

FIG. 8 is a diagram of a top, front view of the shoe and the base plate of the powered coping saw.

### DETAILED DESCRIPTION

This document describes example implementations of a powered coping saw designed to improve the efficiency, accuracy, and precision of coping tasks. The example implementations of the powered coping saw described below are able to make coping cuts faster compared to using a manual, or hand-powered, coping saw.

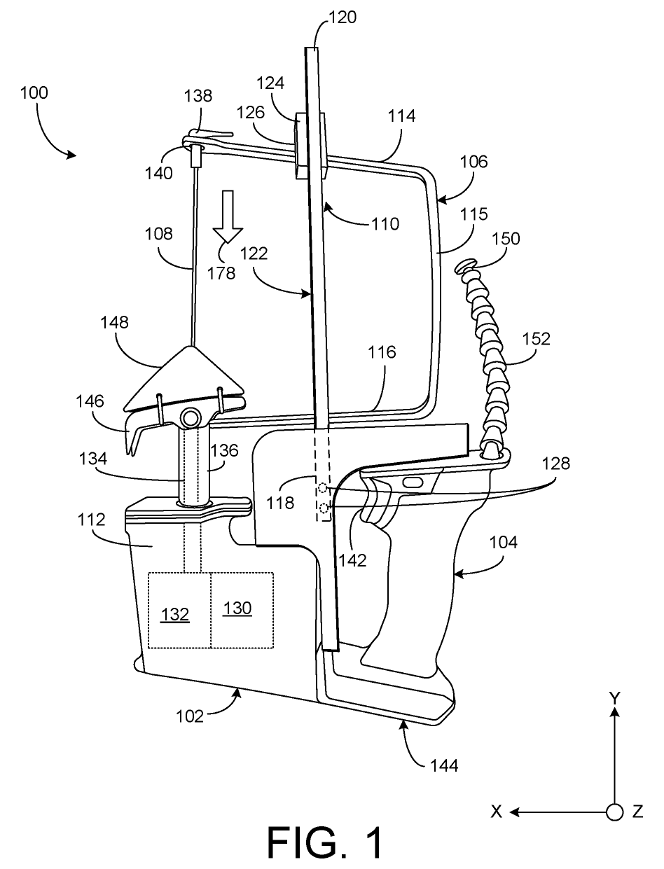

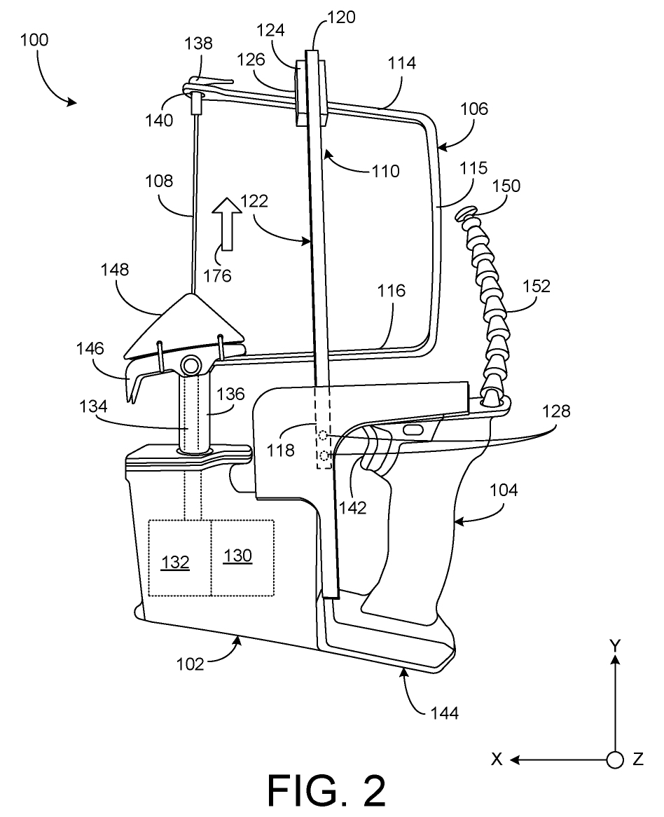

FIG. 1 is a diagram of an example implementation of a powered coping saw 100 in a first position and FIG. 2 is a diagram of the powered coping saw 100 in a second position, where the second position is a different position than the first position. The powered coping saw 100 includes a housing 102, a handle 104, a frame 106, a saw blade 108 attached to the frame 106, a linear mechanism 110, and an actuator 112, among other components as described in further detail below.

The housing 102 forms an outer body or shell of the powered coping saw 100. The housing 102 is a casing that protects various internal components that are housed within the casing, including the actuator 112 and its components. The housing 102 may be constructed from any of a variety of materials, including polymers and/or composites, such as fiberglass-reinforced nylon, which are designed to have high strength and durability. The housing 102 may include some metal sections for added durability and heat dissipation.

As illustrated in FIGS. 1 and 2, the actuator 112 may be at least partially housed in the housing 102. The actuator 112 may be operable to apply a reciprocating motion to the frame 106. Since the saw blade 108 is attached to the frame 106, the reciprocating motion applied by the actuator 112 to the frame 106 also applies the reciprocating motion to the saw blade 108. That is, the actuator 112 applies reciprocating motion to the combination of the frame 106 and the saw blade 108 that is fixed to the frame 106.

The actuator 112 may include an electric motor 130 and a reciprocating mechanism 132. The reciprocating mechanism 132 may be coupled to the electric motor 130 and may be configured to convert rotational motion of the electric motor 130 into the reciprocating motion. For example, the actuator 112 may be aligned parallel to an X-axis depicted for the powered coping saw 100, and the electric motor 130 may be configured to apply rotational force around the X-axis. The reciprocating mechanism 132 may be configured to transfer the rotational force around the X-axis into reciprocating motion along the Y-axis. For example, the reciprocating mechanism 132 may provide reciprocating motion to the frame 106, which is attached to the reciprocating mechanism 132.

In some implementations, the electric motor 130 includes a brushless, direct current (DC) motor. The electric motor 130 may include one or more sensors (e.g., Hall sensors) to enable variable speed control of the electric motor 130. In some implementations, other types of electric motors may be used.

In some implementations, the reciprocating mechanism 132 may include an eccentric cam. The eccentric cam may achieve reciprocating motion by having an off-center cam that translates rotational motion into reciprocating motion through the displacement of the cam profile.

In some implementations, the reciprocating mechanism 132 may include a slider and crank mechanism. The slider and crank mechanism may include a rotating crank that converts the rotational motion of an electric motor into reciprocating motion via a connecting rod that slides within a guide, providing the reciprocating motion as output.

In some implementations, the reciprocating mechanism 132 may include a Scotch yoke mechanism. The Scotch yoke mechanism may translate the rotational motion of the electric motor into reciprocating motion through a yoke that slides back and forth on a guide, driven by a pin attached to a rotating disk, or a crank.

In some implementations, the reciprocating mechanism 132 may include a set of gears to transfer the rotational motion of the electric motor 130 to the reciprocating motion. The set of gears may include a bevel gear set to transfer the rotational motion of the electric motor 130 to the reciprocating motion. In some instances, the rotational motion of the electric motor 130 may occur around one axis (e.g., the y-axis or the z-axis), and the reciprocating mechanism 132 may further include a bevel gear set for transferring the rotational motion from around the one axis (e.g., the y-axis or the z-axis) to around another axis (e.g., the x-axis) before transferring the rotational motion to the reciprocating motion. This may provide additional flexibility in the arrangement of the actuator 112 and the components of the actuator 112. For example, the actuator 112 may be arranged to provide rotational motion around the y-axis, which is parallel to the axis along which the frame 106 travels during reciprocating motion.

Referring to FIGS. 1, 2, and 3A, in some implementations, the reciprocating mechanism 132 may include an adapter 134 that couples the reciprocating mechanism 132 to a second arm 116 of the frame 106. The adapter 134 may include a cylindrical-shaped tube having a first end coupled to the reciprocating mechanism 132 and a second end coupled to a threaded opening 154 on the second arm 116 of the frame 106. The adapter 134 may be at least partially housed or at least partially disposed in an outer shell 136. The outer shell 136 may at least partially enclose the adapter 134. The powered coping saw 100 may include a base plate 146 and a foot 148 coupled to the base plate 146.

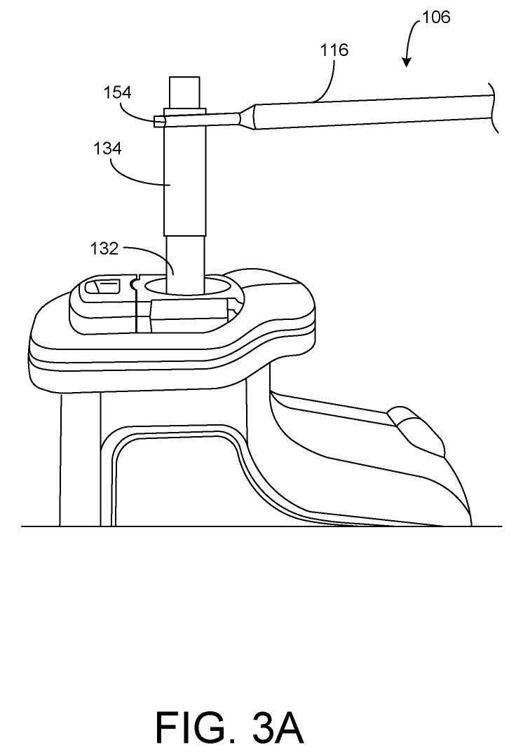

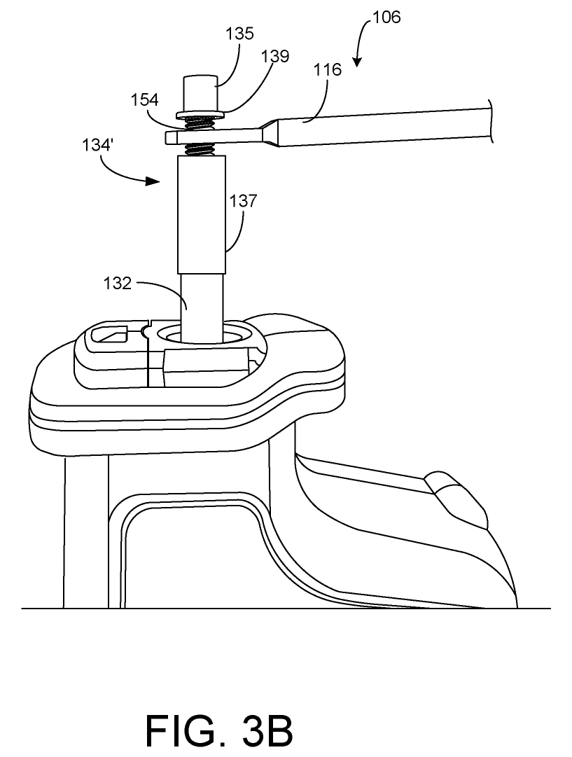

Referring to FIG. 3A, (in which the outer shell 136, the base plate 146, and the foot 148 are not illustrated for purposes of clarity), the adapter 134 may be attached to the frame 106 of the powered coping saw 100. Here, the reciprocating mechanism 132 provides a reciprocating motion. One end of the adapter 134 is fixed to the reciprocating mechanism 132. The other end of the adapter 134 is attached to the second arm 116 of the frame 106. The second arm 116 may include the opening 154 through which the adapter 134 penetrates. The opening 154 may be a threaded opening, and the adapter 134 may include a threaded end that threadably engages with the threaded opening 154. In this manner, the adapter 134 fixes the frame 106 to the reciprocating mechanism 132 so that the reciprocating mechanism 132 can drive and provide reciprocating motion to the frame 106.

Referring to FIG. 3B, (in which the outer shell 136, the base plate 146, and the foot 148 are not illustrated for purposes of clarity), an adapter 134′ may be attached to the frame 106 of the powered coping saw 100, according to another example implementation. The adapter 134′ may include a bolt 135 and a body 137, where the body 137 is affixed to the reciprocating mechanism 132. The bolt 135 may include a cylindrical-shaped member with at least a portion of the member including threads. The body 137 may include a cylindrical-shaped body with a threaded receptacle to receive the threaded portion of the bolt 135. The bolt 135 may go through the threaded opening 154 of the second arm 116 of the frame 106, which may be a threaded opening or may be an unthreaded opening. The bolt 135 may include a lip 139 having a diameter larger than a diameter of the opening 154. In operation, the adapter 134′ fixes the frame 106 to the reciprocating mechanism 132 so that the reciprocating mechanism 132 can drive and provide reciprocating motion to the frame 106 by inserting the bolt 135 through the opening 154 and into the body 137.

In some implementations, the reciprocating mechanism 132 may be attached to or interface with the frame 106 through other means.

The frame 106 may be configured to support the saw blade 108 between a first arm 114 and the second arm 116. The frame 106 also may include a third arm 115 connecting the first arm 114 and the second arm 116. For example, the frame 106 may be U-shaped, C-shaped, or otherwise shaped to enable the first arm 114 and the second arm 116, which are opposing each other, to support the saw blade 108 in between. In some examples, the first arm 114 and the second arm 116 may be substantially parallel to one another. In some implementations, the frame 106 may provide stability and tension for the saw blade 108 while also providing space for the powered coping saw 100 to make deep cuts on a workpiece. For example, the frame 106 may provide tension in instances where the frame 106 is elastic enough to enable the frame 106 to be compressed for attaching or detaching the saw blade 108, such that decompression of the frame 106 provides tension to pull the saw blade 108 taut between the first arm 114 and the second arm 116. In some implementations, the frame 106 may be rigid, and tension for the saw blade 108 may be provided by other means. The frame 106 may be constructed from any of a variety of durable materials, such as high-strength steel, aluminum, or reinforced polymers, to ensure rigidity, elasticity, and/or longevity while maintaining a lightweight design. As discussed, the frame 106 is designed to be reciprocated by the actuator 112, which in turn reciprocates the saw blade 108 that is fixed to the frame 106.

The saw blade 108 is attached to the frame 106 between the first arm 114 and the second arm 116. That is, the saw blade 108 is removably fixed to the frame 106 so that the saw blade 108 reciprocates when the frame 106 reciprocates. In some implementations, the saw blade 108 may include pins or holes at either or both ends to facilitate attaching the saw blade 108 to the powered coping saw 100. The saw blade 108 is designed to be removable, for example, to facilitate replacement, cleaning, and/or the like. In some implementations, the saw blade 108 may be rotatable around an axis along which the frame 106 reciprocates. For example, the saw blade 108 may rotate around a y-axis depicted for the example powered coping saw 100, which may enable the powered coping saw 100 to be used for making cuts at various angles.

In some instances, the saw blade 108 may include a forward-biased tooth configuration. For example, a forward-biased tooth configuration may include a configuration where the teeth of the saw blade 108 are angled toward an end of the powered coping saw 100 opposite the handle 104. In some instances, the saw blade 108 may include a backward-biased tooth configuration. For example, a backward-biased tooth configuration may include a configuration where the teeth of the saw blade 108 are angled away from the end of the powered coping saw 100 opposite the handle 104. In some instances, the saw blade 108 may include a neutrally biased tooth configuration where the teeth of the saw blade 108 are straight (e.g., substantially perpendicular to the axis along which the saw blade 108 reciprocates), rather than angled toward or away from the end of the powered coping saw 100. In some example implementations, the saw blade 108 may include a combination of forward-biased teeth, backward-biased teeth, and/or neutrally biased teeth. The different teeth configurations of the saw blade 108 provide versatility to the powered coping saw 100, enabling the powered coping saw 100 to be used in a variety of situations and for a variety of different cutting styles.

The powered coping saw 100 may include a tensioning mechanism 138. The tensioning mechanism 138 may be coupled to one end of the saw blade 108. The other end of the saw blade 108 may be fixed to the second arm 116 of the frame 106. In some example implementations, the tensioning mechanism 138 may be threadedly engaged with an opening 140 in the first arm 114 of the frame 106 such that rotating the tensioning mechanism 138 may pull the saw blade 108 taut as the first arm 114 and the second arm 116 are drawn closer together. In some other example implementations, the tensioning mechanism 138 may be a pin-and-hole type configuration, where the tension of the saw blade 108 keeps the pin in place. In some implementations, other types of tensioning mechanisms may be used to keep the saw blade 108 taut in the frame 106.

Referring to FIGS. 1, 2, 4, 5A, and 5B, the linear mechanism 110 (also referred to as a linear guide system) linearly constrains the frame 106 and the saw blade 108 as a combined structure or as a single unit as the frame 106 and the saw blade 108 are being reciprocated. The linear mechanism 110 linearly constrains the frame 106 and the saw blade 108 to prevent those components from rotating out of line during operation of the powered coping saw 100 when the powered coping saw 100 is reciprocating. The linear mechanism 110 provides support for the saw blade 108 as it is tensioned between the first arm 114 and the second arm 116 of the frame 106. The support from the linear mechanism 110 reduces non-axial stress at a connection point on the housing 102, as well as keeps the saw blade 108 and the frame 106 from rotating freely about the axis of the connection point.

In an example implementation, the linear mechanism 110 may include a linear rail 122, a linear bearing 124, and a linear adapter 126. Together, these components may form the linear mechanism 110.

The linear rail 122 has a first end 118, which may be affixed/attached to the housing 102. The linear rail 122 may include one or more openings 128 near the first end 118 to enable affixing or attaching the linear rail 122 to the housing 102. The one or more openings 128 and corresponding openings (not shown) on the housing 102 provide the connection point for affixing the linear rail 122 to the housing 102. The linear rail 122 may be attached to the housing 102 using one or more fasteners (not shown) through the one or more openings 128. In some implementations, the linear rail 122 may be attached to the housing 102 by other means.

While the first end 118 is illustrated as being affixed to the housing 102 between the handle 104 and the actuator 112, it is understood that the first end 118 of the linear mechanism 110 may be affixed to the housing 102 in other locations of the housing 102, depending on the overall shape and design of the powered coping saw 100 and the housing 102. For example, in some implementations, the first end 118 of the linear mechanism 110 may be affixed to the housing 102 that houses at least some components of the actuator 112. In some implementations, the first end 118 of the linear mechanism 110 may be affixed to the housing 102 closer to or on the portion of the housing 102 that forms the handle 104. In some implementations, the linear rail 122 may be a square rail. In some implementations, the linear rail 122 may be a cylindrical shaft, that is either solid or hollow. In some implementations, the linear rail 122 may include V-groove rails that feature one or more V-shaped grooves in their running surfaces.

In some implementations, the linear rail 122 may include other shapes and/or designs that enable the linear guide system to function as described herein. In some implementations, the linear rail 122 may be constructed from any of a variety of durable materials, such as high-strength steel, aluminum, or reinforced polymers, to ensure rigidity, elasticity, and/or longevity while maintaining a lightweight design.

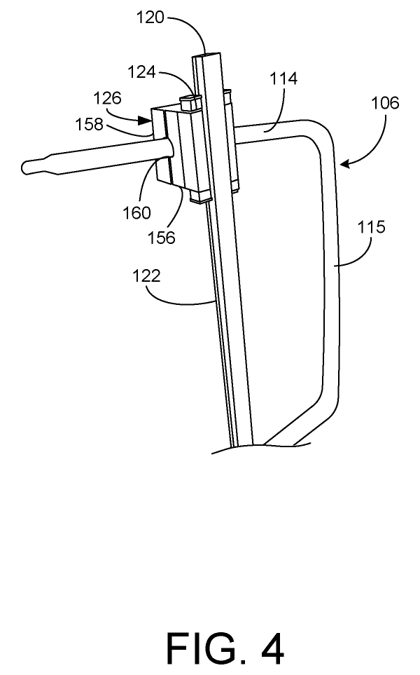

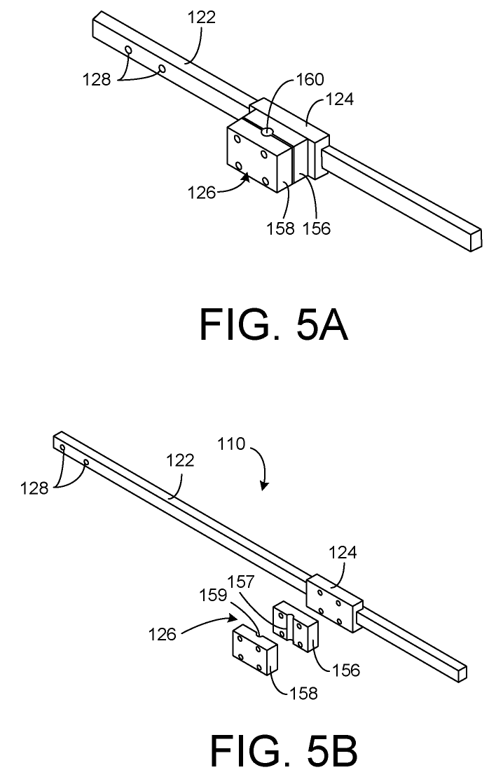

Referring to FIGS. 4, 5A, and 5B, in some implementations, the linear bearing 124 may be slidingly coupled to the linear rail 122 at or near a second end 120 of the linear rail 122. FIG. 4 is a partial diagram of the linear mechanism 110 attached to the frame 106 of the powered coping saw 100, FIG. 5A is an assembled view of the linear mechanism 110, and FIG. 5B is an exploded view of the linear mechanism 110. The linear adapter 126 is fixed to the first arm 114 of the frame 106 and to the linear bearing 124. This provides linear stabilization of the frame 106 as it reciprocates and also enables the frame 106 to slide along the linear rail 122 through the connection of the frame 106 to the linear adapter 126 and the linear bearing 124.

The linear bearing 124, which also may be referred to as a linear slide or a linear guide, is a type of bearing that provides low-friction motion in a straight line. The linear bearing 124 enables the frame 106 to slide along the linear rail 122 smoothly and accurately along a linear path while supporting a load and minimizing friction.

The linear adapter 126 may include a first adapter portion 156 and a second adapter portion 158. The first adapter portion 156 may be attached/affixed to the linear bearing 124. The second adapter portion 158 may be attached/affixed/coupled to the first adapter portion 156. When the first adapter portion 156 is coupled to the second adapter portion 158, an opening 160 is formed from semi-circular grooves 157, 159 in the first adapter portion 156 and the second adapter portion 158, respectively. The opening 160 is configured to receive/surround the first arm 114 of the frame 106.

Referring back to FIGS. 1 and 2, in this example implementation, the handle 104 may be formed from the housing 102. In this example implementation, the housing 102 may extend from the handle 104 to an area that houses at least a portion of the actuator 112 and its components. The housing 102 may enable attachment of the linear mechanism 110 in a center portion of the housing 102 between the handle 104 and the actuator 112. It is understood that the housing 102 may take different shapes and forms to support a weight-balanced and ergonomically user-friendly powered coping saw 100, and that this is merely one example.

In some example implementations, the handle 104 may form a portion of the housing 102. The handle 104 provides an ergonomic grip area for a user to grip the powered coping saw 100. The handle 104 enables the user to wrap their fingers around the handle 104 when using the powered coping saw 100. The handle 104 may be constructed from any of the same materials as the housing 102, including polymers and/or composites, such as fiberglass-reinforced nylon. In some instances, the handle 104 may be at least partially hollow and/or include space for components such as electronic control modules, electrical wiring, other modules, and the like.

In some implementations, the powered coping saw 100 may include a variable speed trigger 142 attached to the handle 104 and operably connected to the actuator 112 for turning the electric motor 130 on and off and for controlling a speed of the reciprocating motion of the frame 106. The variable speed trigger 142 is a type of switch that allows the user to control the operating speed of the powered coping saw 100 by varying how far the variable speed trigger 142 is pulled. For example, pulling the variable speed trigger 142 just slightly results in the frame 106 reciprocating at a low speed. Pulling the variable speed trigger 142 further increases the speed proportionally. Pulling the variable speed trigger 142 all the way results in the frame 106 reciprocating at its maximum speed. A release of the variable speed trigger 142 stops the frame 106 from reciprocating. In some instances, other types of control mechanisms, such as a rotary dial, push-button controls, on/off switches, and/or selectable speed controls, may be used to activate and/or control the speed of the actuator 112.

In some implementations, the powered coping saw 100 may include a battery receptacle 144 that is configured to receive a battery pack (not shown) to power the electric motor 130. The battery receptacle 144 may be located at one end of the handle 104. The battery receptacle 144 may be configured to receive a slide-type battery pack and/or may be configured to receive a tower-type battery pack. In some implementations, the battery pack may include a removable, rechargeable battery pack. The example battery pack may have a nominal voltage of 12V, 18V, 20V, and/or 24V, which may offer varying degrees of power and runtime.

In some implementations, rather than an externally attached battery pack, the handle 104 may be hollow and may include a cavity and connections for an internal integrated battery pack or batteries to be inserted within the handle 104. Additionally, or alternatively, the powered coping saw 100 may be corded to provide a constant source of power.

In some implementations, the powered coping saw 100 may optionally include the base plate 146. The base plate 146 may be coupled to the housing 102 and may include the outer shell 136 that at least partially surrounds the adapter 134. The base plate 146 may be pivotally attached to the frame 106 or to the adapter 134. That is, the base plate 146 may pivot to allow the saw blade 108 to maintain contact with a workpiece or a work surface even if the angle of the saw blade 108 changes during the coping task.

In some implementations, the powered coping saw 100 may optionally include the foot 148 attached to the base plate 146. In the example implementation, the foot 148 may be a pointed foot that is attached to the base plate 146. The foot 148 enables the user to have more support for the workpiece they are working on as well as better maneuverability while performing coping tasks with the powered coping saw 100, including while coping a back angle of a trim workpiece.

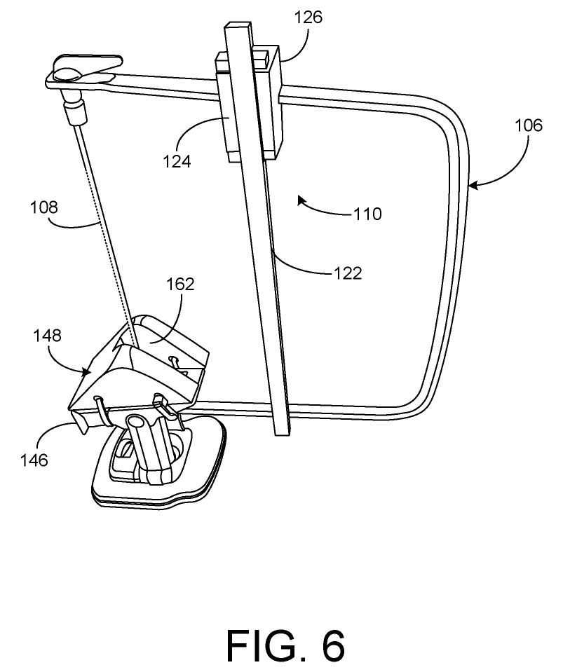

FIG. 6 is a partial diagram of a top view of the powered coping saw 100 of FIG. 1. FIG. 6 illustrates the linear mechanism 110 coupled to the frame 106 through the linear bearing 124 and the linear adapter 126. As the frame 106 reciprocates, the saw blade 108 that is fixed in the frame 106 also reciprocates. The saw blade 108 reciprocates between an opening 162 in the foot 148, which is attached to the base plate 146.

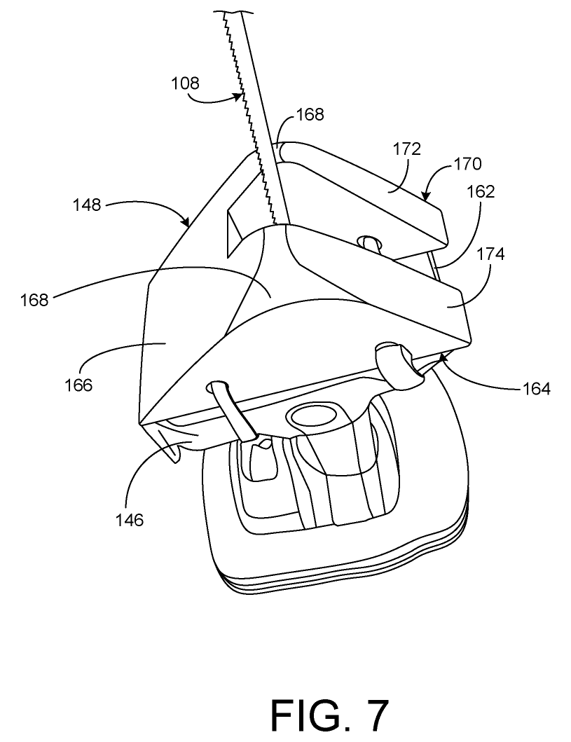

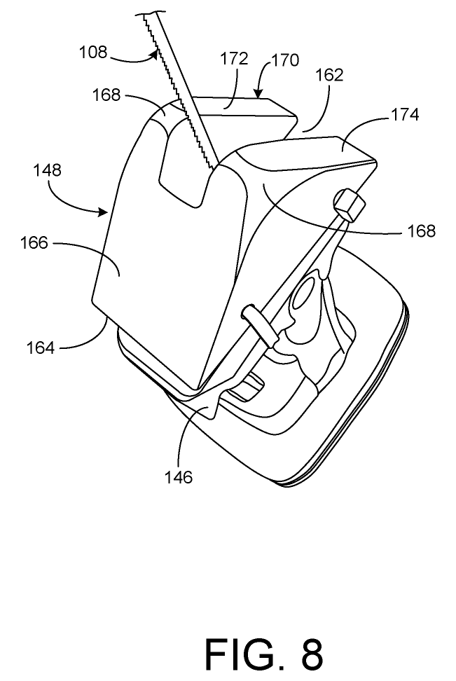

Referring to FIGS. 7 and 8, FIG. 7 is a diagram of a top, side view of the foot 148 and the base plate 146 of the powered coping saw 100 and FIG. 8 is a diagram of a top, front view of the foot 148 and the base plate 146 of the powered coping saw 100. As mentioned above, the foot 148 enables the user to have more support for the workpiece they are working on as well as better control when manipulating the powered coping saw 100 on a workpiece. The foot 148 includes a base 164 attached to the base plate 146, a first flat side 166 that angles from the base 164 to a top portion 168, and a second flat side 170 that angles from the base 164 to the top portion 168, where the second flat side 170 includes a first flat portion 172 and a second flat portion 174 with the opening 162 between the first flat portion 172 and the second flat portion 174. The top portion 168 is flat and tapers from the top portion 168 towards the base 164 along the first flat side 166 and the second flat side 170.

The various flat sides (e.g., the first flat side 166 and the second flat side 170) and the various flat portions (e.g., the first flat portion 172, the second flat portion 174, and the top portion 168) enable the powered coping saw 100 to be manipulated around a workpiece more easily when performing coping tasks.

Referring to FIGS. 1 and 2, in some implementations, the powered coping saw 100 may optionally include a light 150. The light 150 may be attached to the housing 102. For example, the light 150 may be attached above the handle 104 of the housing 102. In some implementations, the light 150 may be encased in an adjustable shell 152. In this manner, the adjustable shell 152 enables the light 150 to be positioned in multiple different orientations and held in a desired position. For example, the adjustable shell 152 enables the light 150 to be manipulated and oriented to direct light on a workpiece to enable the user to more clearly see a trim profile contour when using the powered coping saw 100. The light 150 may receive its power from a power source, such as a battery pack that is received into the battery receptacle 144, or other power source that may provide power to the powered coping saw 100.

FIGS. 1 and 2 also illustrate the movement of the powered coping saw 100 between at least a first position shown in FIG. 1 and a second position shown in FIG. 2. During operation, the frame 106, to which the saw blade 108 is attached, moves generally along the Y-axis, driven by the actuator 112. That is, the actuator 112, including the reciprocating mechanism 132, drives the frame 106 in a reciprocating motion along the Y-axis. At the same time, the linear bearing 124 reciprocates and travels along the linear rail 122, which is affixed at the first end 118 to the housing 102. The linear bearing 124 is coupled to the first arm 114 of the frame 106 via the linear adapter 126 in a manner that enables the linear bearing 124 to slidably engage the linear rail 122.

As shown in FIG. 1, in the first position, the frame 106 is near the top of the handle 104 and the housing 102. More specifically, the second arm 116 of the frame 106 is close to the top of the handle 104 and the housing 102. When the variable speed trigger 142 is pulled, the frame 106 moves away from the handle 104 and the housing 102 in the direction of an arrow 176, as shown in FIG. 2. In the second position, the second arm 116 of the frame 106 is farther away from the top of the handle 104 and the housing 102 as compared to the first position. When the frame 106 reaches a traveling limit in the direction of the arrow 176, the frame 106 returns to the first position in the direction of an arrow 178, as shown in FIG. 1. The frame 106 reciprocates between the first position and the second position, which provides the motion for the saw blade 108 to cut a workpiece.

The terminology used herein is for the purpose of describing particular example implementations only and is not intended to be limiting. As used herein, the singular forms "a," "an," and "the" may be intended to include the plural forms as well, unless the context clearly indicates otherwise. The terms "comprises," "comprising," "including," and "having" are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," "engaged to," "connected to," or "coupled to" another element or layer, it may be directly on, engaged, connected, or coupled to the other element or layer, or intervening elements or layers may be present. In contrast, when an element is referred to as being "directly on," "directly engaged to," "directly connected to," or "directly coupled to" another element or layer, there may be no intervening elements or layers present. Other words used to describe the relationship between elements should be interpreted in a like fashion (e.g., "between" versus "directly between," "adjacent" versus "directly adjacent," etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as "first," "second," and other numerical terms when used herein do not imply a sequence or order unless clearly indicated by the context. Thus, a first element, component, region, layer or section discussed below could be termed a second element, component, region, layer or section without departing from the teachings of the example implementations.

Terms of degree such as "generally," "substantially," "approximately," and "about" may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A coping saw comprising:
a housing having a handle;
a frame having a first arm and a second arm;
a saw blade attached to the frame between the first arm and the second arm;
a linear mechanism having a first end and a second end, the first end affixed to the housing and the second end coupled to the first arm of the frame; and
an actuator attached to the housing and to the second arm of the frame, the actuator operable to apply a reciprocating motion to the frame.

2. The coping saw of claim 1, wherein the linear mechanism comprises:
a linear rail with a first end of the linear rail affixed to the housing; and
a linear bearing coupled to the first arm of the frame and slidably engaged with the linear rail.

3. The coping saw of claim 2, wherein the linear mechanism further comprises a linear adapter coupling the linear bearing to the first arm of the frame.

4. The coping saw of claim 1, wherein the actuator comprises:
an electric motor; and
a reciprocating mechanism coupled to the electric motor to convert rotational motion of the electric motor into the reciprocating motion.

5. The coping saw of claim 4, wherein the reciprocating mechanism further comprises:
a set of gears to transfer the rotational motion of the electric motor to the reciprocating motion.

6. The coping saw of claim 5, wherein the reciprocating mechanism further comprises:
an adapter that couples the reciprocating mechanism to the second arm of the frame.

7. The coping saw of claim 1, further comprising:
a variable speed trigger attached to the handle and operably coupled to the actuator to control a speed of the reciprocating motion of the frame.

8. The coping saw of claim 1, further comprising:
a base plate attached to the housing.

9. The coping saw of claim 8, wherein the base plate is pivotally attached to the housing.

10. The coping saw of claim 8, further comprising:
a foot attached to the base plate.

11. The coping saw of claim 10, wherein the foot comprises:
a base attached to the base plate;
a first flat side that angles from the base to a top portion; and
a second flat side that angles from the base to the top portion, the second flat side having a first flat portion and a second flat portion with an opening between the first flat portion and the second flat portion.

12. The coping saw of claim 1, further comprising:
a light extending from the housing.

13. The coping saw of claim 12, wherein the light is encased in an adjustable shell.

14. A coping saw comprising:
a housing having a handle;
a frame having a first arm and a second arm;
a saw blade attached to the frame between the first arm and the second arm;
a linear mechanism having a first end and a second end, the first end affixed to the housing and the second end coupled to the first arm of the frame;
an actuator attached to the housing and to the second arm of the frame, the actuator operable to apply a reciprocating motion to the frame;
a base plate pivotally attached to the housing; and
a foot attached to the base plate, wherein the foot includes:
a base attached to the base plate;
a first flat side that angles from the base to a top portion; and
a second flat side that angles from the base to the top portion, the second flat side having a first flat portion and a second flat portion with an opening between the first flat portion and the second flat portion.

15. The coping saw of claim 14, wherein the linear mechanism comprises:
a linear rail with a first end of the linear rail affixed to the housing; and
a linear bearing attached to the first arm of the frame, the linear bearing slidably engaged with the linear rail.

16. The coping saw of claim 15, wherein the linear mechanism further comprises a linear adapter coupling the linear bearing to the first arm of the frame.

17. The coping saw of claim 14, wherein the actuator comprises:
an electric motor; and
a reciprocating mechanism coupled to the electric motor to convert rotational motion of the electric motor into the reciprocating motion.

18. The coping saw of claim 17, wherein the reciprocating mechanism further comprises:
a set of gears to transfer the rotational motion of the electric motor to the reciprocating motion.

19. The coping saw of claim 14, further comprising:
a light extending from the housing.

20. The coping saw of claim 19, wherein the light is encased in an adjustable shell.
